(19) United States
(12) Patent Application Publication
(10) Pub. No.: US 2015/0193190 A1
(43) Pub. Date: Jul. 9, 2015

(54) Data Processing Method And Electronic Device

(71) Applicant: Lenovo (Beijing) Co., Ltd., Beijing (CN)

(72) Inventor: Wei Zhong, Beijing (CN)

(73) Assignee: Lenovo (Beijing) Co., Ltd., Beijing (CN)

(21) Appl. No.: 14/459,578

(22) Filed: Aug. 14, 2014

(30) Foreign Application Priority Data
Jan. 6, 2014 (CN) 201410004923.4

(51) Int. Cl. G06F 3/14

(52) U.S. Cl. CPC G06F 3/1454; G06F 3/1423; G09G 2370/16; G09G 2370/045

(57) ABSTRACT

A data processing method applied to a first electronic device capable of communicating with at least one second electronic device is described. The method includes establishing a communication link between the first electronic device and the second electronic device; in the communication link, transmitting, by the first electronic device, first data to the second electronic device via a first predetermined interface; when the second electronic device displays the first data simultaneously with the first electronic device, transmitting, by the first electronic device, second data to the second electronic device via a second predetermined interface; wherein the first data and the second data are different. With the invention, an electronic device is capable of achieving transmission of non screen sync displayed data while performing screen sync display between the first electronic device and the second electronic device.

### BACKGROUND

This application claims priority to Chinese patent application No. 201410004923.4 filed on Jan. 6, 2014; the entire contents of which are incorporated herein by reference.

The present disclosure relates to information processing technology, and more particularly to a data processing method and an electronic device

WiFi (Wireless Fidelity), Bluetooth, Infrared, New wireless network data communication Zigbee and other technologies, as short-range wireless communications technology, are known intimately by a wide range of users with their respective advantages. Among them, WiFi having a high-speed transmission rate has gain an appreciation of majority of users.

In WiFi network, using Miracast protocol can achieve wireless screen sync function between a source device (Source end) and a host device (Sink end), using HTTP (Hypertext Transfer Protocol) or FTP (File Transfer Protocol) or other text transfer protocols can achieve data transmission between the Source end and Sink end.

Among them, Miracast protocol facilitates transmission of information data between the source device, Source end, and the host device, Sink end. For example, when a smart phone serves as the Source end, an LCD TV serves as the Sink end, in consideration of that a display screen of the LCD TV is larger and more convenient for the users to view, a P2P (Peer to Peer) link is established between the smart phone and the LCD TV through the Miracast protocol to achieve a screen sync display between the smart phone and the LCD TV, i.e., content displayed on the LCD TV maintains real-time synchronization with content displayed on the smart phone. The screen sync display between the Source end and the Sink end takes up a lot bandwidth of the WiFi network, in this case, when the smart phone desires to transmit other files besides the content displayed on the display screen, such as an application packet, to the LCD TV via the Miracast protocol, it needs to first disconnect the P2P link, re-establish a link and carry out transmission of the application packet on the re-established link, but in this moment the re-established link cannot achieve a screen sync display function between the Source end and the Sink end. In other words, the P2P link established based on the Miracast protocol cannot achieve a screen sync display function between the Source end and the Sink end and a transmission function of the application packet concurrently. A solution capable of carrying out transmission of the application packet while performing screen sync display between the Source end and the Sink end is expected urgently.

### SUMMARY

To solve the problem existing in the prior art, embodiments of the disclosure provide a data processing method and an electronic device capable of achieving transmission of non screen sync displayed data while performing screen sync display between the Source end and the Sink end.

To achieve the above aim, the technical solution of the embodiments of the present disclosure is implemented by:

An embodiment of the present disclosure provides a data processing method applied to a first electronic device capable of communicating with at least one second electronic device, the method comprising:

establishing a communication link between the first electronic device and the second electronic device;

in the communication link, transmitting, by the first electronic device, first data to the second electronic device via a first predetermined interface; when the second electronic device displays the first data simultaneously with the first electronic device, transmitting, by the first electronic device, second data to the second electronic device via a second predetermined interface;

wherein the first data and the second data are different.

In the above-described solution, the method further comprises:

transmitting, by the first electronic device, a link establishment request to the second electronic device via the first interface; after receiving a response from the second electronic device via the first interface, establishing the communication link.

In the above-described solution, the method further comprises:

in a control-layer protocol frame of the communication link, adding a flag bit for identifying whether the first electronic device supports transmission of the second data;

when the flag bit identifies that the first electronic device supports transmission of the second data, enabling the second interface and configuring a transmission parameter for the second data; and

when the second electronic device displays the first data simultaneously with the first electronic device, transmitting, by the first electronic device, the second data in accordance with a text transfer protocol and a transmission rate specified in the transmission parameter through the enabled second interface.

In the above-described solution, the method further comprises:

detecting a transmission rate at which the first electronic device transmits the first data;

when the transmission rate at which the first electronic device transmits the first data is lower than a preset first rate threshold, controlling a transmission rate of the second data to increase;

when the transmission rate at which the first electronic device transmits the first data is higher than a preset first rate threshold, controlling a transmission rate of the second data to decrease;

wherein the first rate threshold is smaller than the second rate threshold.

An embodiment of the present disclosure further provides an electronic device capable of communicating with at least one second electronic device that includes a display unit, the electronic device comprising an establishing unit, a first transmitting unit , a display unit, and a second transmitting unit, wherein:

the establishing unit is configured to establish a communication link with the second electronic device;

the first transmitting unit is configured to, in the communication link, transmit first data to the second electronic device via a first predetermined interface;

the display unit is configured to, when displaying the first data simultaneously with the display unit of the second electronic device, trigger the second transmitting unit;

the second transmitting unit is configured to transmit second data to the second electronic device via a second predetermined interface;

wherein the first data and the second data are different.

In the above-described solution, the first transmitting unit is further configured to transmit a link establishment request to the second electronic device via the first interface; and trigger the establishing unit after receiving a response from the second electronic device via the first interface.

In the above-described solution, the electronic device further comprises: an adding unit, an enabling unit, and a configuring unit,

the adding unit is configured to, in a control-layer protocol frame of the communication link, add a flag bit for identifying whether the first electronic device supports transmission of the second data;

the enabling unit is configured to when the flag bit identifies that the first electronic device supports transmission of the second data, enable the second interface and trigger the configuring unit;

the configuring unit is configured to configure a transmission parameter for the second data;

accordingly, the display unit is configured to trigger the second transmitting unit when displaying the first data simultaneously with the display unit of the first electronic device;

the second transmitting unit is configured to transmit the second data in accordance with a text transfer protocol and a transmission rate specified in the transmission parameter through the enabled second interface.

In the above-described solution, a detecting unit, a first control unit, and a second control unit:

the detecting unit is configured to detect a transmission rate at which the first electronic device transmits the first data;

the first control unit is configured to, when the transmission rate at which the first electronic device transmits the first data is lower than a preset first rate threshold, control a transmission rate of the second data to increase;

the second control unit is configured to when the transmission rate at which the first electronic device transmits the first data is higher than a preset first rate threshold, control a transmission rate of the second data to decrease;

wherein the first rate threshold is smaller than the second rate threshold.

Embodiments of the present disclosure provide a data processing method and an electronic device, the data processing method applied to a first electronic device capable of communicating with at least one second electronic device, the method comprising: establishing a communication link between the first electronic device and the second electronic device; in the communication link, transmitting, by the first electronic device, first data to the second electronic device via a first predetermined interface; when the second electronic device displays the first data simultaneously with the first electronic device, transmitting, by the first electronic device, second data to the second electronic device via a second predetermined interface; wherein the first data and the second data are different. With the technical solutions in the embodiments of the present disclosure, it is capable of achieving transmission of non screen sync displayed data while performing screen sync display between the Source end and the Sink end.

### BRIEF DESCRIPTION OF THE DRAWINGS

FIG. 1 is a flowchart of a first embodiment of the data processing method provided by the present disclosure;

FIG. 2 is a flowchart of a second embodiment of the data processing method provided by the present disclosure;

FIG. 3 is a flowchart of a third embodiment of the data processing method provided by the present disclosure;

FIG. 4 is a schematic view of composition of a first embodiment of the electronic device provided by the present disclosure;

FIG. 5 is a schematic view of composition of a second embodiment of the electronic device provided by the present disclosure; and

FIG. 6 is a schematic view of composition of a third embodiment of the electronic device provided by the present disclosure.

### DETAILED DESCRIPTION

Hereinafter, the technical solutions of the present disclosure will be further described in detail in conjunction with the accompanying drawings and specific embodiments.

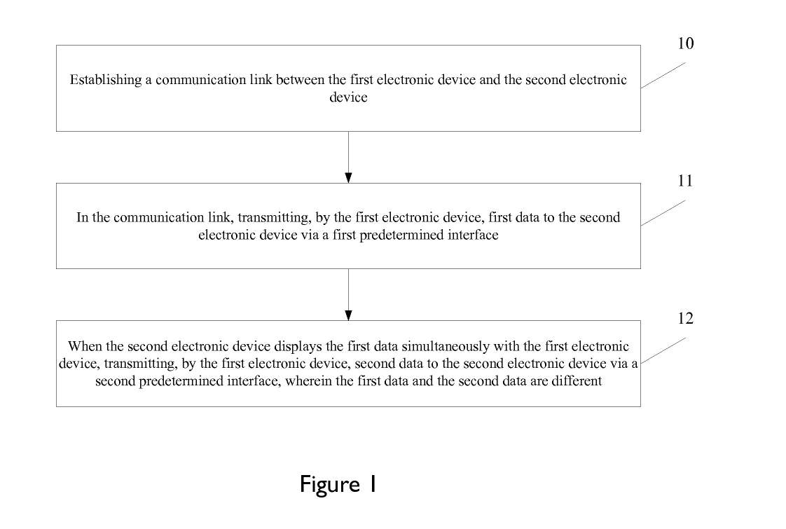

The present disclosure provides a first embodiment of a data processing method applied to a first electronic device capable of communicating with at least one second electronic device, the first electronic device may be a smart phone, the second electronic device may be a liquid crystal television, a smart phone, a computer etc; FIG. 1 is a flowchart of a first embodiment of the data processing method provided by the present disclosure, as shown in FIG. 1, the method comprises: Step 10: establishing a communication link between the first electronic device and the second electronic device.

In this embodiment, a first interface is provided for a Source end and a Sink end respectively; and transmission/reception of a link establishment request and first data is carried out via the first interface. The Source end transmits a link establishment request to the Sink end via the first interface; the Sink end receives the link establishment request, and returns a response message for the link establishment request to the Source end via the first interface; thereby a WiFi link based on Miracast protocol is established between the Source end and the Sink end.

Step 11: in the communication link, transmitting, by the first electronic device, first data to the second electronic device via a first predetermined interface.

In this embodiment, the first interface is used to transmit the first data, and the first data is screen sync displayed between the devices at the Source end and the Sink end.

Step 12: when the second electronic device displays the first data simultaneously with the first electronic device, transmitting, by the first electronic device, second data to the second electronic device via a second predetermined interface; wherein the first data and the second data are different.

Herein, in order to ensure that transmission of the first data and that of the second data do not affect each other, a second interface is provided at the Source end and the Sink end, respectively, so that the second data is transmitted from the Source end to the Sink end via a path different from that for the first data.

The second data may be an application packet, a picture etc.; in the embodiment of the present disclosure, it is possible to carry out transmission of non screen sync displayed data between the Source end and the Sink end while carrying out the screen sync display of the first data between the Source end and the Sink end, the Sink end can automatically install the second data such as an application packet.

From the above, with the solution of this embodiment, different interfaces are provided for the Source end and the Sink end respectively to carry out different transmissions, thus achieving the transmission of the second data from the Source end to the Sink end while screen sync displaying the first data at the Source end and the Sink end based on the WiFi link.

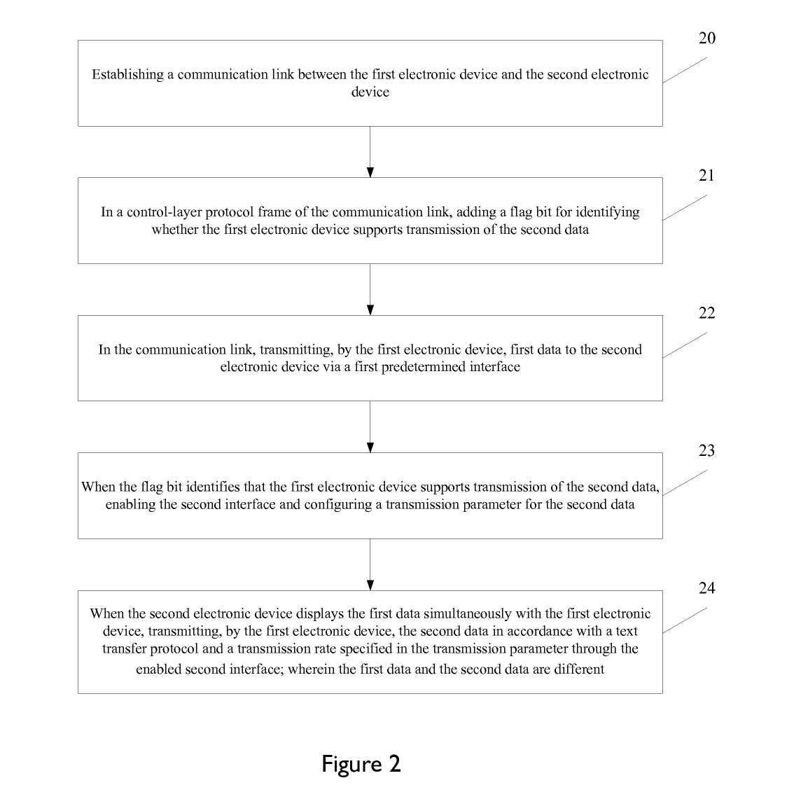

The present disclosure provides a second embodiment of a data processing method applied to a first electronic device capable of communicating with at least one second electronic device, the first electronic device may be a smart phone, the second electronic device may be a liquid crystal television, a smart phone, a computer etc; FIG. 2 is a flowchart of a second embodiment of the data processing method provided by the present disclosure, as shown in FIG. 2, the method comprises:

Step 20: establishing a communication link between the first electronic device and the second electronic device.

In this embodiment, a first interface is provided for a Source end and a Sink end respectively; and transmission/reception of a link establishment request and first data is carried out via the first interface. The Source end transmits a link establishment request to the Sink end via the first interface; the Sink end receives the link establishment request, and returns a response message for the link establishment request to the Source end via the first interface; thereby a WiFi link based on Miracast protocol is established between the Source end and the Sink end.

Step 21: in a control-layer protocol frame of the communication link, adding a flag bit for identifying whether the first electronic device supports transmission of the second data.

Herein, in a control-layer protocol frame of the WiFi link, such as RTSP (Real Time Streaming Protocol) protocol frame, a flag bit for identifying whether the Source end and the Sink end support transmission of the second data different from the first data is added. After establishing the WiFi link, the Source end transmits an inquiry message to the Sink end via the first interface, to inquire whether the flag bit is contained in the a protocol frame used by the Sink end; when it is determined that the flag bit is contained in the protocol frame used by the Sink end, the Sink end returns a response message for the inquiry message to the Source end via the first interface. Meanwhile, the Sink end transmits an inquiry message to the Source end via the first interface, to inquire whether the flag bit is also contained in a protocol frame used by the Source end; when it is determined that the flag bit is contained in the protocol frame used by the Source end, the Source end returns a response message for the inquiry message to the Sink end via the first interface. The above process is a handshake process of the Source end and the Sink end, and is for determining whether the Source end and the Sink end support a transmission function of the second data.

Step 22: in the communication link, transmitting, by the first electronic device, first data to the second electronic device via a first predetermined interface.

In this embodiment, the first data is transmitted using the first interface, and the first data is screen sync displayed between the Source end and the Sink end.

Step 23: when the flag bit identifies that the first electronic device supports transmission of the second data, enabling the second interface and configuring a transmission parameter for the second data.

Herein, in order to ensure that transmission of the first data and that of the second data do not affect each other, a second interface is provided at the Source end and the Sink end, respectively, so that the second data is transmitted from the Source end to the Sink end via a path different from that for the first data. And a transmission mode is configured for the second data, the transmission mode includes: a text transfer protocol used during transmission, such as HTTP, FTP, a transmission interface (second interface), a transmission rate; furthermore, the transmission mode further includes: an instruction for compressed or uncompressed transmission for the second data, an instruction for whether to support continue transferring from breakpoint, an associated application after the second data is transmitted to the Sink end, such as that the Sink end automatically installs the second data after receiving the second data etc.

Step 24: when the second electronic device displays the first data simultaneously with the first electronic device, transmitting, by the first electronic device, the second data in accordance with a text transfer protocol and a transmission rate specified in the transmission parameter through the enabled second interface; wherein the first data and the second data are different.

Here, the second data may be an application packet, a picture etc.; in the embodiment of the present disclosure, it is possible to carry out transmission of non screen sync displayed data between the Source end and the Sink end while carrying out the screen sync display of the first data between the Source end and the Sink end, the Sink end can automatically install the second data such as an application packet.

From the above, with the solution of this embodiment, a transmission interface is added, and improvement is made to structure of the control-layer protocol frame, thereby function of supporting transmission of the second data while screen sync displaying the first data at the Source end and the Sink end is configured, thus achieving the transmission of the second data from the Source end to the Sink end while screen sync displaying the first data at the Source end and the Sink end based on the WiFi link.

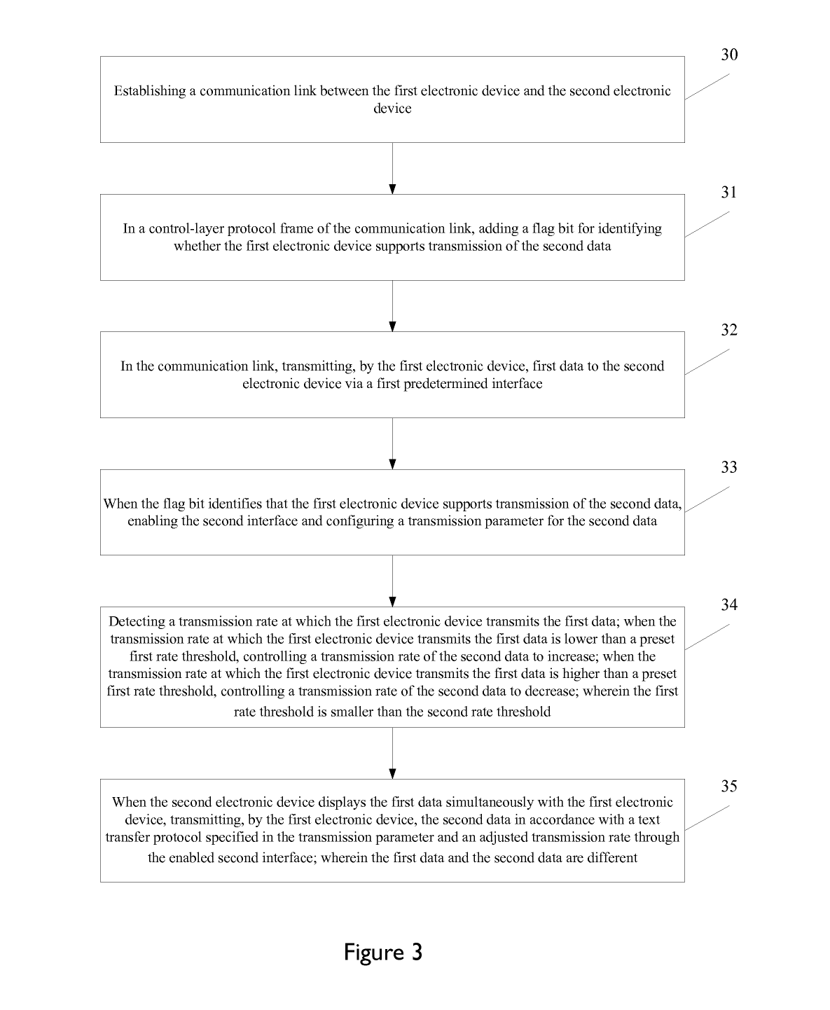

The present disclosure provides a third embodiment of a data processing method applied to a first electronic device capable of communicating with at least one second electronic device, the first electronic device may be a smart phone, the second electronic device may be a liquid crystal television, a smart phone, a computer etc; FIG. 3 is a flowchart of a third embodiment of the data processing method provided by the present disclosure, as shown in FIG. 3, the method comprises:

Step 30: establishing a communication link between the first electronic device and the second electronic device.

In this embodiment, a first interface is provided for a Source end and a Sink end respectively; and transmission/reception of a link establishment request and first data is carried out via the first interface. The Source end transmits a link establishment request to the Sink end via the first interface; the Sink end receives the link establishment request, and returns a response message for the link establishment request to the Source end via the first interface; thereby a WiFi link based on Miracast protocol is established between the Source end and the Sink end.

Step 31: in a control-layer protocol frame of the communication link, adding a flag bit for identifying whether the first electronic device supports transmission of the second data.

Herein, in a control-layer protocol frame of the WiFi link, such as RTSP (Real Time Streaming Protocol) protocol frame, a flag bit for identifying whether the Source end and the Sink end support transmission of the second data different from the first data is added. After establishing the WiFi link, the Source end transmits an inquiry message to the Sink end via the first interface, to inquire whether the flag bit is contained in a protocol frame used by the Sink end; when it is determined that the flag bit is contained in the protocol frame used by the Sink end, the Sink end returns a response message for the inquiry message to the Source end via the first interface. Meanwhile, the Sink end transmits an inquiry message to the Source end via the first interface, to inquire whether the flag bit is also contained in a protocol frame used by the Source end; when it is determined that the flag bit is contained in the protocol frame used by the Source end, the Source end returns a response message for the inquiry message to the Sink end via the first interface. The above process is a handshake process of the Source end and the Sink end, and is for determining whether the Source end and the Sink end support a transmission function of the second data.

Step 32: in the communication link, transmitting, by the first electronic device, first data to the second electronic device via a first predetermined interface.

In this embodiment, the first data is transmitted using the first interface, and the first data is screen sync displayed between the Source end and the Sink end.

Step 33: when the flag bit identifies that the first electronic device supports transmission of the second data, enabling the second interface and configuring a transmission parameter for the second data.

Herein, in order to ensure that transmission of the first data and that of the second data do not affect each other, a second interface is provided at the Source end and the Sink end, respectively, so that the second data is transmitted from the Source end to the Sink end via a path different from that for the first data. And a transmission mode is configured for the second data, the transmission mode includes: a text transfer protocol used during transmission, such as HTTP, FTP, a transmission interface (second interface), a transmission rate; furthermore, the transmission mode further includes: an instruction for compressed or uncompressed transmission for the second data, an instruction for whether to support continue transferring from breakpoint, an associated application after the second data is transmitted to the Sink end, such as that the Sink end automatically installs the second data after receiving the second data etc.

Step 34: detecting a transmission rate at which the first electronic device transmits the first data; when the transmission rate at which the first electronic device transmits the first data is lower than a preset first rate threshold, controlling a transmission rate of the second data to increase; when the transmission rate at which the first electronic device transmits the first data is higher than a preset first rate threshold, controlling a transmission rate of the second data to decrease; wherein the first rate threshold is smaller than the second rate threshold.

Since the bandwidths used for the transmission of the first data and the second data both are bandwidth of the WiFi link, in the case that the bandwidth is fixed, in order to ensure that the screen sync display of the first display data can satisfy the users' visual experience, the transmission rate of the second data needs to be adjusted according to the transmission rate of the first data. Levels of the transmission rate of the second data set in advance are a low level, a middle level, and a high level; each level of the transmission rate may be a value range of rate or a specific value of rate, which may be self-set. By default, the level of the transmission rate of the second data is controlled in the middle level; when detecting that the transmission rate of the first data is lower than a preset first rate threshold, the transmission rate of the second data is controlled to increase to the high level rate from the middle level rate; when the transmission rate of the first data is higher than a preset first rate threshold, the transmission rate of the second data is controlled to decrease to the low level rate from the middle level rate; wherein the first rate threshold is smaller than the second rate threshold.

Step 35: when the second electronic device displays the first data simultaneously with the first electronic device, transmitting, by the first electronic device, the second data in accordance with a text transfer protocol specified in the transmission parameter and an adjusted transmission rate through the enabled second interface; wherein the first data and the second data are different.

Here, the second data may be an application packet, a picture etc.; in the embodiment of the present disclosure, it is possible to carry out transmission of non screen sync displayed data between the Source end and the Sink end while carrying out the screen sync display of the first data between the Source end and the Sink end, the Sink end can automatically install the second data such as an application packet.

From the above, with the solution of this embodiment, a transmission interface is added, and improvement is made to structure of the control-layer protocol frame, thereby function of supporting transmission of the second data while screen sync displaying the first data at the Source end and the Sink end is configured, thus achieving the transmission of the second data from the Source end to the Sink end while screen sync displaying the first data at the Source end and the Sink end based on the WiFi link; meanwhile, in consideration of the problem that the bandwidth is fixed in the WiFi link, the transmission rate of the second data may vary along with change of the transmission rate of the first data.

The present disclosure provides a first embodiment of an electronic device capable of communicating with at least one second electronic device that includes a display unit. The electronic device may be regarded as a Source end, the second electronic device as a Sink end.

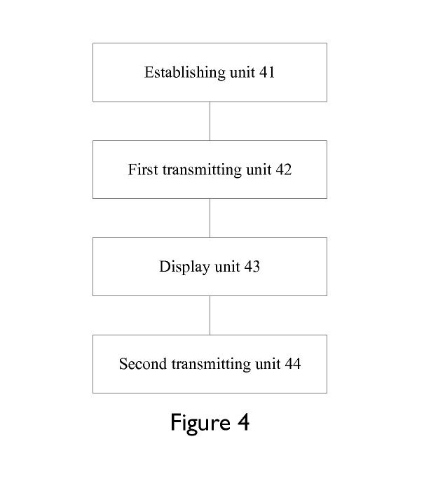

FIG. 4 is a schematic view of composition of a first embodiment of the electronic device provided by the present disclosure; as shown in FIG. 4, the electronic device comprises an establishing unit 41, a first transmitting unit 42, a display unit 43, a second transmitting unit 44, wherein:

the establishing unit 41 is configured to establish a communication link with the second electronic device;

the first transmitting unit 42 is configured to, in the communication link, transmit first data to the second electronic device via a first predetermined interface;

the display unit 43 is configured to, when displaying the first data simultaneously with the display unit of the second electronic device, trigger the second transmitting unit;

the second transmitting unit 44 is configured to transmit second data to the second electronic device via a second predetermined interface;

wherein the first data and the second data are different.

In this embodiment, a first interface is provided for the Source end and the Sink end respectively; and transmission/reception of a link establishment request and first data is carried out via the first interface. The Source end, the first transmitting unit 42 in particular, transmits a link establishment request to the Sink end via the first interface; the Sink end receives the link establishment request, and returns a response message for the link establishment request to the Source end, the first transmitting unit 42 in particular, via the first interface; the establishing unit 41 established a WiFi link based on Miracast protocol between the Source end and the Sink end.

Herein, in order to ensure that transmission of the first data and that of the second data do not affect each other, a second interface is provided at the Source end and the Sink end, respectively, so that the second data is transmitted from the Source end to the Sink end via a path different from that for the first data.

The second data may be an application packet, a picture etc.; in the embodiment of the present disclosure, it is possible to carry out transmission of non screen sync displayed data between the Source end and the Sink end while carrying out the screen sync display of the first data between the Source end and the Sink end, the Sink end can install the second data such as an application packet.

From the above, with the solution of this embodiment, different interfaces are provided for the Source end and the Sink end to carry out different transmissions, respectively, thus achieving the transmission of the second data from the Source end to the Sink end while screen sync displaying the first data at the Source end and the Sink end based on the WiFi link.

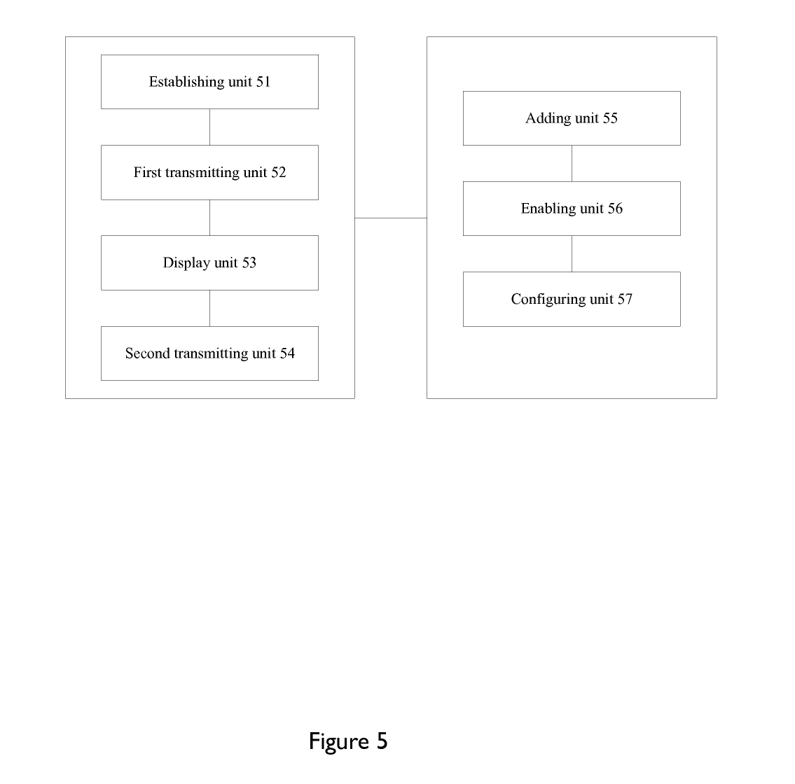

FIG. 5 is a schematic view of composition of a second embodiment of the electronic device provided by the present disclosure; as shown in FIG. 5, the electronic device comprises: an establishing unit 51, a first transmitting unit 52, a display unit 53, a second transmitting unit 54, an adding unit 55, an enabling unit 56, and a configuring unit 57; wherein:

the establishing unit 51 is configured to establish a communication link with the second electronic device.

Here, a first interface is provided for the Source end and the Sink end respectively; and transmission/reception of a link establishment request and first data is carried out via the first interface. The Source end, the first transmitting unit 52 in particular, transmits a link establishment request to the Sink end via the first interface; the Sink end receives the link establishment request, and returns a response message for the link establishment request to the Source end, the first transmitting unit 52 in particular, via the first interface; the establishing unit 51 established a WiFi link based on Miracast protocol between the Source end and the Sink end.

The adding unit 55 is configured to, in a control-layer protocol frame of the communication link; add a flag bit for identifying whether the first electronic device supports transmission of the second data.

Herein, in a control-layer protocol frame of the WiFi link, such as RTSP (Real Time Streaming Protocol) protocol frame, the adding unit 55 adds a flag bit for identifying whether the Source end and the Sink end support transmission of the second data different from the first data. After the establishing unit 51 establishes the WiFi link, the Source end, the first transmitting unit 52 in particular, transmits an inquiry message to the Sink end via the first interface, to inquire whether the flag bit is contained in a protocol frame used by the Sink end; when it is determined that the flag bit is contained in the protocol frame used by the Sink end, the Sink end returns a response message for the inquiry message to the Source end via the first interface. Meanwhile, the Sink end sink transmits an inquiry message to the Source end via the first interface, to inquire whether the flag bit is contained in a protocol frame used by the Source end, a determining unit in particular (not shown); when the determining unit of the Source end determines that the flag bit is contained in the protocol frame used by the Source end, the Source end, the first transmitting unit 52 in particular, returns a response message for the inquiry message to the Sink end via the first interface. The above process is a handshake process of the Source end and the Sink end, and is for determining whether the Source end and the Sink end support a transmission function of the second data.

The first transmitting unit 52 is configured to, in the communication link, transmit first data to the second electronic device via a first predetermined interface;

the enabling unit 56 is configured to when the flag bit identifies that the first electronic device supports transmission of the second data, enable the second interface and trigger the configuring unit 57;

the configuring unit 57 is configured to configure a transmission parameter for the second data.

Herein, in order to ensure that transmission of the first data and that of the second data do not affect each other, a second interface is provided at the Source end and the Sink end, respectively, so that the second data is transmitted from the Source end to the Sink end via a path different from that for the first data. The configuring unit 57 configures a transmission mode for the second data, the transmission mode includes: a text transfer protocol is used during transmission, such as HTTP, FTP, a transmission interface (second interface), a transmission rate; furthermore, the transmission mode further includes: an instruction for compressed or uncompressed transmission for the second data, an instruction for whether to support continue transferring from breakpoint, an associated application after the second data is transmitted to the Sink end, such as that the Sink end automatically installs the second data after receiving the second data etc.

The display unit 53 is configured to, when displaying the first data simultaneously with the display unit of the second electronic device, trigger the second transmitting unit 54;

the second transmitting unit 54 is configured to transmit second data to the second electronic device via a second predetermined interface;

wherein the first data and the second data are different.

From the above, with the solution of this embodiment, a transmission interface is added, and improvement is made to structure of the control-layer protocol frame, thereby function of supporting transmission of the second data while screen sync displaying the first data at the Source end and the Sink end is configured, thus achieving the transmission of the second data from the Source end to the Sink end while screen sync displaying the first data at the Source end and the Sink end based on the WiFi link.

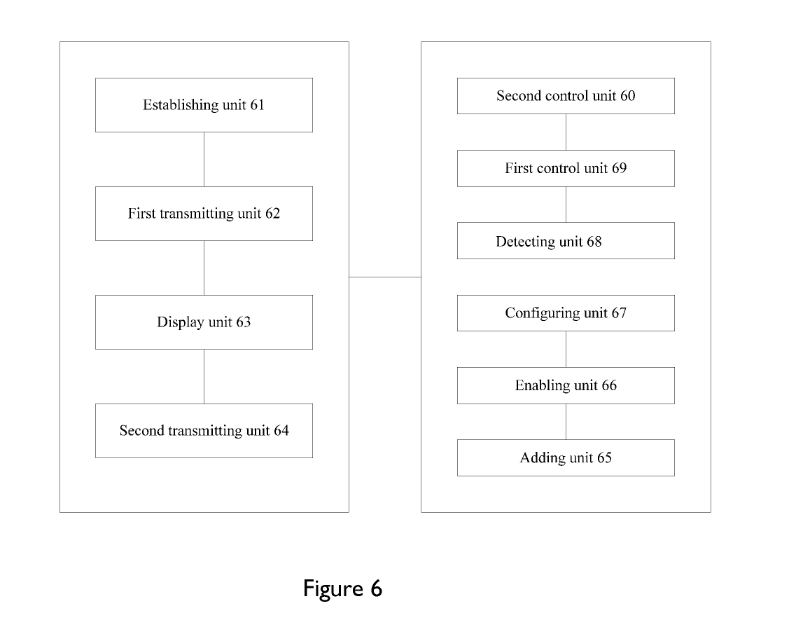

FIG. 6 is a schematic view of composition of a third embodiment of the electronic device provided by the present disclosure; as shown in FIG. 6, the electronic device comprises: an establishing unit 61, a first transmitting unit 62, a display unit 63, a second transmitting unit 64, an adding unit 65, an enabling unit 66, a configuring unit 67, a detecting unit 68, a first control unit 69, and a second control unit 60; wherein:

the establishing unit 61 is configured to establish a communication link with the second electronic device.

Here, a first interface is provided for the Source end and the Sink end respectively; and transmission/reception of a link establishment request and first data is carried out via the first interface. The Source end, the first transmitting unit 62 in particular, transmits a link establishment request to the Sink end via the first interface; the Sink end receives the link establishment request, and returns a response message for the link establishment request to the Source end, the first transmitting unit 62 in particular, via the first interface; the establishing unit 61 establishes a WiFi link based on Miracast protocol between the Source end and the Sink end.

The adding unit 65 is configured to, in a control-layer protocol frame of the communication link, add a flag bit for identifying whether the first electronic device supports transmission of the second data.

Herein, in a control-layer protocol frame of the WiFi link, such as RTSP (Real Time Streaming Protocol) protocol frame, the adding unit 65 adds a flag bit for identifying whether the Source end and the Sink end support transmission of the second data different from the first data. After the establishing unit 61 establishes the WiFi link, the Source end, the first transmitting unit 62 in particular, transmits an inquiry message to the Sink end via the first interface, to inquire whether the flag bit is contained in a protocol frame used by the Sink end; when it is determined that the flag bit is contained in the protocol frame used by the Sink end, the Sink end returns a response message for the inquiry message to the Source end via the first interface. Meanwhile, the Sink end sink transmits an inquiry message to the Source end via the first interface, to inquire whether the flag bit is contained in a protocol frame used by the Source end, a determining unit in particular (not shown); when the determining unit of the Source end determines that the flag bit is contained in the protocol frame used by the Source end, the Source end, the first transmitting unit 62 in particular, returns a response message for the inquiry message to the Sink end via the first interface. The above process is a handshake process of the Source end and the Sink end, and is for determining whether the Source end and the Sink end support a transmission function of the second data.

The first transmitting unit 62 is configured to, in the communication link, transmit first data to the second electronic device via a first predetermined interface;

The enabling unit 66 is configured to when the flag bit identifies that the first electronic device supports transmission of the second data, enable the second interface and trigger the configuring unit 67;

The configuring unit 67 is configured to configure a transmission parameter for the second data.

Herein, in order to ensure that transmission of the first data and that of the second data do not affect each other, a second interface is provided at the Source end and the Sink end, respectively, so that the second data is transmitted from the Source end to the Sink end via a path different from that for the first data. The configuring unit 67 configures a transmission mode for the second data, the transmission mode includes: a text transfer protocol is used during transmission, such as HTTP, FTP, a transmission interface (second interface), a transmission rate; furthermore, the transmission mode further includes: an instruction for compressed or uncompressed transmission for the second data, an instruction for whether to support continue transferring from breakpoint, an associated application after the second data is transmitted to the Sink end, such as that the Sink end automatically installs the second data after receiving the second data etc.

The detecting unit 68 is configured to detect a transmission rate at which the first electronic device transmits the first data;

the first control unit 69 is configured to, when the transmission rate at which the first electronic device transmits the first data is lower than a preset first rate threshold, control a transmission rate of the second data to increase;

the second control unit 60 is configured to when the transmission rate at which the first electronic device transmits the first data is higher than a preset first rate threshold, control a transmission rate of the second data to decrease; wherein the first rate threshold is smaller than the second rate threshold.

Here, since the bandwidths used for the transmission of the first data and the second data both are bandwidth of the WiFi link, in the case that the bandwidth is fixed, in order to ensure that the screen sync display of the first display data can satisfy the users' visual experience, the transmission rate of the second data needs to be adjusted according to the transmission rate of the first data. Levels of the transmission rate of the second data set in advance are a low level, a middle level, and a high level; each level of the transmission rate may be a value range of rate or a specific value of rate, which may be self-set. By default, the level of the transmission rate of the second data is controlled in the middle level; when the first control unit 69 determines that the transmission rate of the first data detected by the detecting unit 68 is lower than a preset first rate threshold, it controls the transmission rate of the second data to increase to the high level rate from the middle level rate; when the second control unit 60 determines that the transmission rate of the first data detected by the detecting unit 68 is higher than a preset first rate threshold, it controls the transmission rate of the second data to decrease to the low level rate from the middle level rate; wherein the first rate threshold is smaller than the second rate threshold.

The display unit 63 is configured to, when displaying the first data simultaneously with the display unit of the second electronic device, trigger the second transmitting unit;

the second transmitting unit 64 is configured to transmit second data to the second electronic device via a second predetermined interface;

wherein the first data and the second data are different.

From the above, with the solution of this embodiment, a transmission interface is added, and improvement is made to structure of the control-layer protocol frame, thereby function of supporting transmission of the second data while screen sync displaying the first data at the Source end and the Sink end is configured, thus achieving the transmission of the second data from the Source end to the Sink end while screen sync displaying the first data at the Source end and the Sink end based on the WiFi link; meanwhile, in consideration of the problem that the bandwidth is fixed in the WiFi link, the transmission rate of the second data may vary along with change of the transmission rate of the first data.

In the several embodiments provided by the present application, it should be understood that the disclosed device and method may be implemented by other ways. The device embodiments described above are merely illustrative, for example, the division of the units only is a logical division of functions, there may be other division manners in practical implementations, for instance, a plurality of units or components may be combined, or may be integrated in another system, or certain features may be omitted or not carried out. Further, the coupling or direct coupling or communicative connection between the respective components shown or discussed therein may be carried out via certain interfaces, and indirect coupling or communicative connection between devices or units may be electrical, mechanical, or others forms.

The above units described as a separate member may be, or may not be physically separated, the components shown as a unit may or may not be a physical unit; they may be located in one place, or may be disposed on a plurality of network units; it is possible to select parts or all units among them according to actual needs to achieve the aim of the solution of the embodiments.

In addition, the respective functional units in the respective embodiments of the present disclosure may be all integrated within one processing unit, and it may also be that each unit serves as a unit independently, it may also be that two or more units are integrated within one unit; the aforesaid integrated unit not only can be implemented in the form of hardware, but also can be implemented in the form of hardware plus software functional units.

A person of ordinary skill in the art can understand that, all or parts of the steps for implementing the aforesaid method embodiments may be completed through hardware related to the program instructions, the program may be stored in a computer readable storage medium, these steps of the above method embodiments are executed when the program is executed; the storage medium comprises a removable storage device, a Read-Only Memory (ROM), a Random Access Memory (RAM), a magnetic disk, or an optical disk, and other various mediums that can store program codes.

Alternatively, when the above integrated unit of the present disclosure is implemented in the form of software functional modules and sold and used as an independent product, it is possible to store in a computer readable storage medium. Based on such understanding, the substance or the parts that contribute over the prior art of the technical solution of the embodiments of the present disclosure may be embodied in the form of a software product, this computer software product is stored in a storage medium, which includes several instructions in use for causing a computer device (which may be a personal computer, a serve; or a network equipment) to implement all or parts of the method of various embodiments of the present disclosure. The foresaid storage medium includes a removable storage device, a Read-Only Memory (ROM), a Random Access Memory (RAM), a magnetic disk, or an optical disk, and other various mediums that can store program codes.

The above are only specific embodiments of the present disclosure, however, the protection scope of the present disclosure is not limited thereto, variations or replacements that are readily conceivable for those skilled in the art within the technical scope disclosed by the present disclosure should all fall into the protection scope of the present disclosure. Accordingly, the protection scope of the present disclosure should be subjected to the protection scope of the claims.

1. A data processing method applied to a first electronic device capable of communicating with at least one second electronic device, the method comprising:
establishing a communication link between the first electronic device and the second electronic device;
in the communication link, transmitting, by the first electronic device, first data to the second electronic device via a first predetermined interface; and when the second electronic device displays the first data simultaneously with the first electronic device, transmitting, by the first electronic device, second data to the second electronic device via a second predetermined interface;
wherein the first data and the second data are different.

2. The method according to claim 1, wherein the method further comprises transmitting, by the first electronic device, a link establishment request to the second electronic device via the first interface; and after receiving a response from the second electronic device via the first interface, establishing the communication link.

3. The method according to claim 1, wherein the method further comprises:
in a control-layer protocol frame of the communication link, adding a flag bit for identifying whether the first electronic device supports transmission of the second data;
when the flag bit identifies that the first electronic device supports transmission of the second data, enabling the second interface and configuring a transmission parameter for the second data; and
when the second electronic device displays the first data simultaneously with the first electronic device, transmitting, by the first electronic device, the second data in accordance with a text transfer protocol and a transmission rate specified in the transmission parameter through the enabled second interface.

4. The method according to claim 3, wherein the method further comprises:
detecting a transmission rate at which the first electronic device transmits the first data;
when the transmission rate at which the first electronic device transmits the first data is lower than a preset first rate threshold, controlling a transmission rate of the second data to increase;
when the transmission rate at which the first electronic device transmits the first data is higher than a preset first rate threshold, controlling a transmission rate of the second data to decrease;
wherein the first rate threshold is smaller than the second rate threshold.

5. An electronic device capable of communicating with at least one second electronic device that includes a display unit, the electronic device comprising an establishing unit, a first transmitting unit, a display unit, and a second transmitting unit, wherein:
the establishing unit is configured to establish a communication link with the second electronic device;
the first transmitting unit is configured to, in the communication link, transmit first data to the second electronic device via a first predetermined interface;
the display unit is configured to, when displaying the first data simultaneously with the display unit of the second electronic device, trigger the second transmitting unit;
the second transmitting unit is configured to transmit second data to the second electronic device via a second predetermined interface;
wherein the first data and the second data are different.

6. The electronic device according to claim 5, wherein the first transmitting unit is further configured to transmit a link establishment request to the second electronic device via the first interface; and trigger the establishing unit after receiving a response from the second electronic device via the first interface.

7. The electronic device according to claim 5, further comprising: an adding unit, an enabling unit, and a configuring unit,
the adding unit is configured to, in a control-layer protocol frame of the communication link, add a flag bit for identifying whether the first electronic device supports transmission of the second data;
the enabling unit is configured to, when the flag bit identifies that the first electronic device supports transmission of the second data, enable the second interface and trigger the configuring unit;
the configuring unit is configured to configure a transmission parameter for the second data;
wherein the display unit is configured to trigger the second transmitting unit when displaying the first data simultaneously with the display unit of the first electronic device;
the second transmitting unit is configured to transmit the second data in accordance with a text transfer protocol and a transmission rate specified in the transmission parameter through the enabled second interface.

8. The electronic device according to claim 7, wherein the electronic device further comprises: a detecting unit, a first control unit, and a second control unit:
the detecting unit is configured to detect a transmission rate at which the first electronic device transmits the first data;
the first control unit is configured to, when the transmission rate at which the first electronic device transmits the first data is lower than a preset first rate threshold, control a transmission rate of the second data to increase;
the second control unit is configured to when the transmission rate at which the first electronic device transmits the first data is higher than a preset first rate threshold, control a transmission rate of the second data to decrease;
wherein the first rate threshold is smaller than the second rate threshold.
